(19) United States
(12) Patent Application Publication
(10) Pub. No.: US 2013/0090583 A1
(43) Pub. Date: Apr. 11, 2013

(54) BALL ACUPRESSURE DEVICE

(71) Applicant: Jin Sang Jung, Seongnam-si (KR)

(72) Inventor: Jin Sang Jung, Seongnam-si (KR)

(73) Assignee: KWANG ZIN, Seongnam-si, Gyeonggi-do (KR)

(21) Appl. No.: 13/704,691

(22) PCT Filed: Jun. 13, 2011
(86) PCT No.: PCT/KR2011/004311

§ 371 Date: Dec. 17, 2012

(30) Foreign Application Priority Data
Jun. 18, 2010 (KR) 10-2010-0058148

(51) Int. Cl. A61H 15/00

(52) U.S. Cl. CPC A61H 15/0092
USPC 601/131

(57) ABSTRACT

The present invention relates to a ball acupressure device capable of stably fixing internal components and at the same time, performing smooth rotary functions. The invention comprises: a housing body having an opening on the upper part thereof; a fixed ring which is arranged in a state of being placed on the bottom of the housing body; a first bearing which is arranged on the fixed ring; a first rotary ring which is arranged on the first bearing; a second bearing which is arranged on the first rotary ring; a second rotary ring which is arranged on the second bearing to allow a rolling rotation thereon; an acupressure part which is accommodated in the inside part the first rotary ring and the second rotary ring, and in which a plurality of protrusive acupressure pins are formed on the outer side thereof; and a clamp which supports the acupressure part to enable rotation, and at the same time enables rotation on the second rotary ring, wherein an end that prevents separation curves to the inside of the opening and is formed on the upper rim of the housing body, and a ball bearing is interposed between the end that prevents separation and the second rotary ring.

### TECHNICAL FIELD

The present invention relates to a ball acupressure device, and particularly to, a ball acupressure device which can stably secure internal components and, at the same time, perform smooth rotation.

### BACKGROUND ART

In general, an acupressure device is an instrument that promotes blood circulation in such a manner that projections projecting outward intensively press a specific area of the body.

Recently, various types of instruments capable of maximizing the effect of acupressure have been disclosed. As a typical example thereof, an acupressure device provided with an acupressure part in the form of a ball disclosed in Korean Patent No. 0710516 (hereinafter, referred to as “prior art”) will be schematically described.

As shown in FIG. 1, an acupressure device 100 according to the prior art comprises an open hollow housing 110, a bearing 130 provided in the circumferential direction in the housing 110, a lower ring 120 and an upper ring 140 rollably provided at the top and bottom of the bearing 130, a clamp 160 including two hinge rods 162 rotatably connected to the upper ring 140 in facing positions and a bearing 161 provided between the two hinge rods 162, and an acupressure part 150 freely rotating about the clamp 160 by means of the bearing 161 and including a plurality of acupressure pins 151 projecting from the circumferential surface thereof.

However, since the acupressure device according to the prior art has a structure in which the lower ring, the bearing, and the upper ring are sequentially stacked in the open hollow of the housing in a simple inserting manner, when the open hollow of the housing is tilted vertically or turned upside down, all internal components are separated from the housing, thus decreasing the portability, or when the housing drops from a predetermined height, the respective components that constitute the acupressure device are easily damaged by the impact.

Moreover, since the housing is in contact with a locking protrusion of the housing and thus cannot rotate, it is difficult to smoothly rotate the acupressure part only with the rotational force of the upper ring.

### DISCLOSURE

### Technical Problem

The present invention has been made to solve the above-described problems, and an object of the present invention is to provide a ball acupressure device which can stably secure internal components provided in a housing and can rotate more softly and smoothly.

### Technical Solution

To achieve the above-described object, the present invention provides a ball acupressure device comprising: a housing body including an opening on the top; a fixed ring placed on the bottom of the housing body; a first bearing provided on the fixed ring; a first rotating ring disposed on the top of the first bearing; a second bearing disposed on the top of the first rotating ring; a second rotating ring rollably disposed on the top of the second bearing; an acupressure part received inside the first rotating ring and the second rotating ring and including a plurality of acupressure pins projecting from the outer surface; and a clamp rotatably supporting the acupressure part and rotatably provided on the second rotating ring, wherein a separation preventing protrusion bent toward the inside of the opening is formed on the upper edge of the housing body, and a plurality of ball bearings are interposed between the separation preventing protrusion and the second rotating ring.

Moreover, the housing body comprises an upper housing and a lower housing, which are connected to and disconnected from each other in the vertical direction.

Furthermore, a plurality of receiving grooves, in which the ball bearings are received, are formed at regular intervals on the outer circumference of the second rotating ring.

In addition, an auxiliary bearing is interposed between the clamp and the acupressure part.

In particular, each of the first bearing and the second bearing comprises a disc member including a plurality of connecting holes formed in the circumferential direction and a plurality of balls rollably connected to the connecting holes of the disc member, and a curved groove is formed on an upper surface or lower surface of the first rotating ring and the second rotating ring which are in rolling contact with the balls.

Moreover, the acupressure part comprises a first acupressure part and a second acupressure part, which are connected to and disconnected from each other in the vertical direction, and a projection member detachably connected to the outer circumference of the first acupressure part and the second acupressure part.

Meanwhile, a connecting means for increasing the binding force of the first acupressure part and the second acupressure part is provided in the acupressure part.

Furthermore, the clamp comprises a hinge rod of which both ends are eccentrically bent.

In particular, the projection member is made of various materials according to users' preferences.

Moreover, locking rings including through holes are provided on both outer sides of the upper housing.

Furthermore, an anti-skid pad is provided on the bottom surface of the lower housing.

### Advantageous Effects

According to the present invention, since the separation preventing protrusion is provided in the housing body, it is possible to prevent the components provided therein from escaping to the outside or being damaged, thus diversifying the use of the product and improving the functional efficiency such as convenience of use, etc. Moreover, since the first bearing and the second bearing are interposed between the fixed ring and the first rotating ring and between the first rotating ring and the second rotating ring, respectively, which are provided in the housing body and the plurality of ball bearings are interposed between the separation preventing protrusion of the upper housing and the second rotating ring, the frictional resistance of the first rotating ring and the second rotating ring is significantly reduced during rotation, thus allowing the first rotating ring and the second rotating ring to rotate more softly and smoothly.

Furthermore, since the hinge rod formed on the clamp has a structure in which both ends are eccentrically bent, the acupressure part can be continuously and rapidly rotated in all directions of 360 degrees.

### DESCRIPTION OF DRAWINGS

FIG. 1 is a cross-sectional view showing the configuration of an acupressure device according to a prior art.

FIG. 2 is a perspective view showing a ball acupressure device according to the present invention.

FIG. 3 is an exploded perspective view of FIG. 2.

FIG. 4 is a cross-sectional view of FIG. 2.

FIG. 5 is a plan view showing another example of a locking ring formed on an upper housing of FIG. 2.

FIG. 6 is a plan view showing various examples of the structure of a hinge rod of FIG. 2.

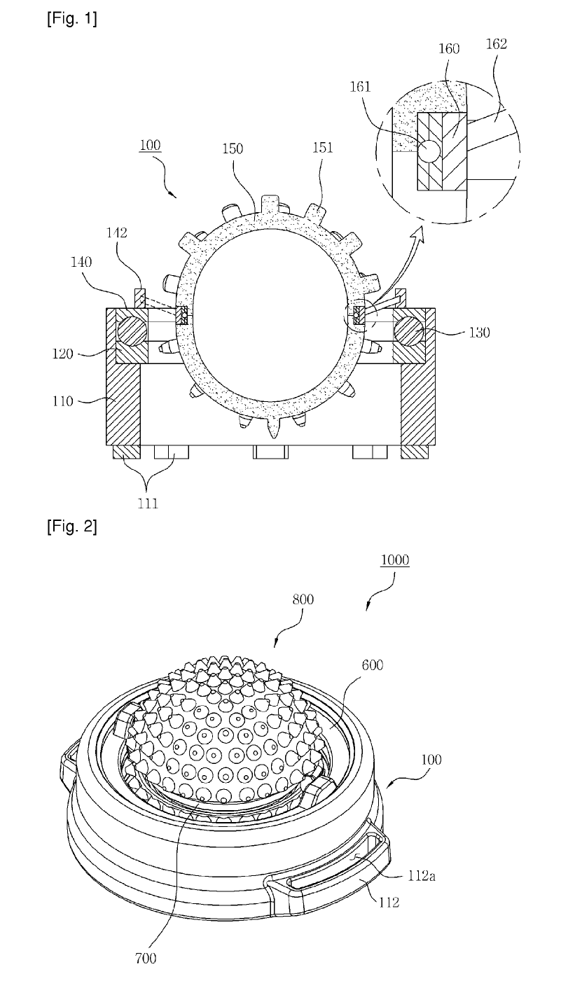

### MODE FOR INVENTION

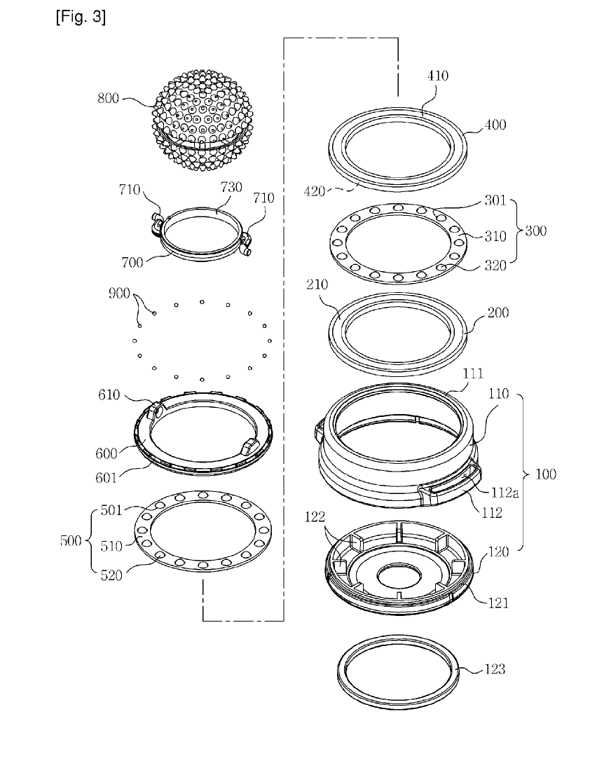

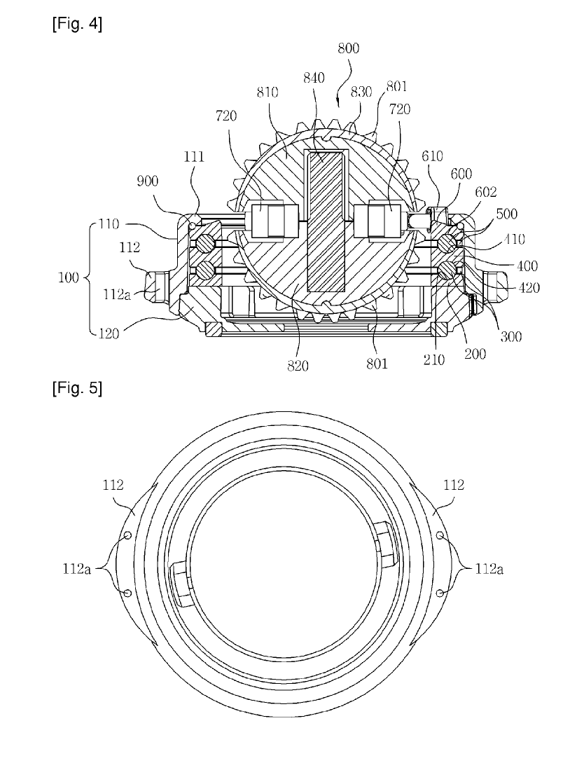

Hereinafter, preferred embodiments of the present invention will be described in detail with reference to FIGS. 2 to 4.

As shown, a ball acupressure device 1000 according to the present invention comprises a housing body 100, a fixed ring 200 placed on the bottom of the housing body 100, a first bearing 300 provided on the fixed ring 200, a first rotating ring 400 rollably placed on the top of the first bearing 300, a second bearing 500 disposed on a curved groove 410 formed in the circumferential direction of the first rotating ring 400, a second rotating ring 600 rollably placed on the top of the second bearing 500, a clamp 700 rotatably connected to the second rotating ring 600 and rotatably supporting an acupressure part 800, which will be described later, and the acupressure part 800 having the form of a ball freely rotated by the clamp 700 and including a plurality of acupressure pins 801 projecting in the circumferential direction.

First, the housing body 100 is a receptacle that receives a part of the acupressure part 800 to rotate in all directions and may preferably comprise an upper housing 110 and a lower housing 120 to be connected and disconnected to each other. However, the upper housing 110 and the lower housing 120 may be formed integrally.

Moreover, it is preferred that the outer circumference of the lower housing 120 has a wide-top-narrow-bottom structure in which the width gradually decreases from the top to the bottom to provide a slim appearance.

The upper housing 110 is a substantially hollow cylindrical member and includes a separation preventing protrusion 111 bent toward the inside of the hollow.

The separation preventing protrusion 111 serves to essentially prevent the internal components, which will be described later, from escaping to the outside when the housing body 100 drops from a predetermined height.

Moreover, locking rings 112 each including through holes 112a, to which a separate locking mechanism is coupled, are provided on both outer sides of the upper housing 110, thus increasing the portability and preventing theft or loss.

Although not shown in the figures, a Velcro strap (not shown), which secures a user's hand by wrapping, may be further provided.

The Velcro strap is provided to allow the user to use the acupressure device by wearing it without holding the housing body 100 by hand.

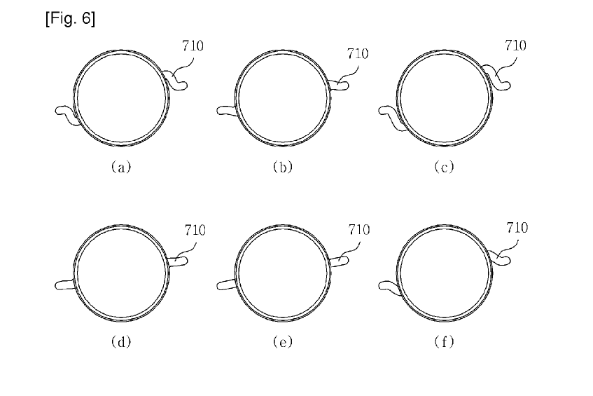

Furthermore, as shown in FIG. 5, the locking rings 112 may be configured to have a structure in which two or more through holes 112a are formed.

The through holes 112a are provided to carry the acupressure device by tying a slender connecting strand without using the Velcro strap.

Moreover, various forms of advertisements may be printed on the outer surface of the upper housing 110 to increase advertising effects.

The lower housing 120 includes a fastening member 121 detachably inserted to the upper housing 110 and formed in the circumferential direction thereof.

Here, although it is described that the fastening member 121 includes a locking protrusion to be inserted into the upper housing 110, the present invention is not necessarily limited thereto, and the fastening member 121 may include a screw part to be fastened by the screw part.

Moreover, a plurality of support pieces 122 are formed at predetermined intervals in the circumferential direction on the inner circumference of the lower housing 120.

Furthermore, an anti-skid pad 123 is provided on the bottom surface of the lower housing 120 to be stably fixed to an installation surface.

The housing body 100 having the above-described configuration has a detachable structure, and thus it is possible to more effectively perform maintenance and inspection of the internal components and to prevent the internal component from escaping or being damaged by an external impact due to the separation preventing protrusion 111 formed on the upper housing 110.

Meanwhile, the components such as the fixed ring 200, the first bearing 300, the first rotating ring 400, the second bearing 500, the second rotating ring 600, the clamp 700, and the acupressure part 800 are sequentially stacked in the housing body 100.

First, the fixed ring 200 is a hollow disc and is placed on the support pieces 122 of the lower housing 120 to support the first bearing 300, and a curved groove 210 is formed on the upper surface of the disc to facilitate the rolling of the first bearing 300. Of course, the surface of the curved groove 210 is worked to be smooth.

The first bearing 300 and the second bearing 500 comprise disc members 310 and 510, each including a plurality of connecting holes 301 and 501 formed in the circumferential direction, and balls 320 and 520 rollably connected to the connecting holes 301 and 501 of the disc members 310 and 510, respectively.

The first rotating ring 400 and the second rotating ring 600 are discs having the same diameter as the fixed ring 200 and are smoothly rotated by the first bearing 300 and the second bearing 500.

In particular, curved grooves 410 and 420 which are in rolling contact with the second bearing 500 and the first bearing 300 are formed on the upper and lower surfaces of the first rotating ring 400, respectively.

A curved groove 602 which is in rolling contact with the second bearing 500 is formed on the lower surface of the second rotating ring 600.

That is, the first bearing 300 and the second bearing 500 are interposed between the fixed ring 200 and the first rotating ring 400 and between the first rotating ring 400 and the second rotating ring 600 to reduce the frictional resistance due to the relative rotation therebetween, thus allowing the first rotating ring 400 and the second rotating ring 600 to rotate more softly and smoothly.

Moreover, connecting members 610 to which the clamp 700, which will be described later, is rotatably connected are formed on both sides facing each other with respect to the rotation center of the second rotating ring 600.

Furthermore, a plurality of ball bearings 900 are interposed between the separation preventing protrusion 111 of the upper housing 110 and the second rotating ring 600. The plurality of ball bearings 900 are received in receiving grooves 601 formed at regular intervals on the outer circumference of the second rotating ring 600 to support the relative rotation between the second rotating ring 600 and the separation preventing protrusion 111.

The ball bearings 900 serve to prevent the rotational force of the second rotating ring 600 from being reduced, which is caused by that the separation preventing protrusion 111 of the upper housing 110 and the second rotating ring 600 are in frictional contact with each other during rotation of the second rotating ring 600.

The clamp 700 has a ring shape and comprises a ring connection 730 provided to surround the center of the outer circumference of the acupressure part 800, which will be described later, and hinge rods 710 formed to face each other with respect to the center of the ring connection 730.

The hinge rods 710 are rotatably inserted into the connecting members 610 formed on the second rotating ring 600.

Here, it is preferable that each of the hinge rods 710 be bent in a substantially Z shape such that one end of the hinge rod 710 is connected to the connecting members 610 and the other end is eccentrically fixed to the ring connection 730 as shown in FIG. 2, but the present invention is not necessarily limited thereto, and the hinge rod 710 may have various structures in which its one end is eccentric in the vertical or horizontal direction as shown in FIG. 6.

This is to generate a force that rapidly rotates the acupressure part 800 to one side of the second rotating ring 600 with respect to the center of the hinge rod 710 such that the acupressure part 800 can be easily rotated toward the hinge rod 710, when the operating force of the acupressure part 800 acts along a straight line connecting the hinge points of the hinge rods 710 and the connecting members 610 from the axial center of the acupressure part 800.

That is, due to the eccentric hinge rod 710, even when the force acts toward the hinge rod 710, the acupressure part 800 is not stopped but continuously rotated in all directions of 360 degrees.

Moreover, it is preferable that auxiliary bearings 720 be interposed between the clamp 700 and the acupressure part 800 such that the acupressure part 800 can be rotated in the longitudinal and transverse directions.

Meanwhile, the acupressure part 800 is a component in the form of a ball and is rotatably connected by the clamp 700.

In detail, the acupressure part 800 may comprise a first acupressure part 810 and a second acupressure part 820, which are connected to and disconnected from each other in the vertical direction, and a projection member 830 detachably connected to the outer circumference of the first acupressure part 810 and the second acupressure part 820.

Of course, the acupressure part 800 may have a hollow shape configured only with the projection member 830 without the auxiliary bearings 720.

A connecting means 840 for increasing the fastening force of the first acupressure part 810 and the second acupressure part 820 may be provided in the center of the acupressure part 800.

The connecting means 840 may include various connecting tools such as screw bolts, magnets, etc.

The acupressure pins 801 formed on the projection member 830 have a conical shape, but the present invention is not necessarily limited thereto, and the acupressure pins 801 may have various sizes and shapes.

In particular, the projection member 830 is detachably connected to the first acupressure part 810 and the second acupressure part 820 and may be made of various materials such as metal, silicone, rubber, jade, wood, etc. according to the users' physical characteristics or preferences, thus improving the users' satisfaction.

Of course, the projection member 830 and the acupressure pins 801 formed on the outer surface thereof may be made of different materials and integrated.

According to the ball acupressure device 1000 having the above-described configuration of the present invention, since the separation preventing protrusion 111 is provided in the housing body 100, it is possible to prevent the components provided therein from escaping to the outside or being damaged, thus diversifying the use of the product and improving the functional efficiency such as convenience of use, etc. Moreover, since the first bearing 300 and the second bearing 500 are interposed between the fixed ring 200 and the first rotating ring 400 and between the first rotating ring 400 and the second rotating ring 600, respectively, which are provided in the housing body 100 and the plurality of ball bearings 900 are interposed between the separation preventing protrusion 111 of the upper housing 110 and the second rotating ring 600, the frictional resistance of the first rotating ring 400 and the second rotating ring 600 is significantly reduced compared to the conventional one, thus allowing the first rotating ring 400 and the second rotating ring 600 to rotate more softly and smoothly.

Moreover, since the projection member is detachably connected and made of various materials, it is possible to improve the users' satisfaction according to their preferences.

1. A ball acupressure device comprising:
a housing body including an opening on the top;
a fixed ring placed on the bottom of the housing body;
a first bearing provided on the fixed ring;
a first rotating ring disposed on the top of the first bearing;
a second bearing disposed on the top of the first rotating ring;
a second rotating ring rollably disposed on the top of the second bearing;
an acupressure part received inside the first rotating ring and the second rotating ring and including a plurality of acupressure pins projecting from the outer surface; and
a clamp rotatably supporting the acupressure part and rotatably provided on the second rotating ring,
wherein a separation preventing protrusion bent toward the inside of the opening is formed on the upper edge of the housing body, and a plurality of ball bearings are interposed between the separation preventing protrusion and the second rotating ring.

2. The ball acupressure device of claim 1, wherein the housing body comprises an upper housing and a lower housing, which are connected to and disconnected from each other in the vertical direction.

3. The ball acupressure device of claim 1, wherein a plurality of receiving grooves, in which the ball bearings are received, are formed at regular intervals on the outer circumference of the second rotating ring.

4. The ball acupressure device of claim 1, wherein an auxiliary bearing is interposed between the clamp and the acupressure part.

5. The ball acupressure device of claim 1, wherein each of the first bearing and the second bearing comprises a disc member including a plurality of connecting holes formed in the circumferential direction and a plurality of balls rollably connected to the connecting holes of the disc member, and a curved groove is formed on an upper surface or lower surface of the first rotating ring and the second rotating ring which are in rolling contact with the balls.

6. The ball acupressure device of claim 1, wherein the acupressure part comprises a first acupressure part and a second acupressure part, which are connected to and disconnected from each other in the vertical direction, and a projection member detachably connected to the outer circumference of the first acupressure part and the second acupressure part.

7. The ball acupressure device of claim 6, wherein a connecting means for increasing the binding force of the first acupressure part and the second acupressure part is provided in the acupressure part.

8. The ball acupressure device of claim 6, wherein the clamp comprises a hinge rod of which both ends are eccentrically bent.

9. The ball acupressure device of claim 8, wherein the projection member is made of various materials according to users' preferences.

10. The ball acupressure device of claim 2, wherein locking rings including through holes are provided on both outer sides of the upper housing.

11. The ball acupressure device of claim 10, wherein an anti-skid pad is provided on the bottom surface of the lower housing.
